(19) United States
(12) Patent Application Publication
(10) Pub. No.: US 2003/0115137 A1
(43) Pub. Date: Jun. 19, 2003

(54) Method and system for utilizing accounts to obtain music and promote music purchases

(76) Inventor: Richard E. Rowe, Las Vegas, NV (US)

Correspondence Address: WEIDE & MILLER, LTD., 330 S. 3RD STREET, SUITE 1130, LAS VEGAS, NV, 89101, US

(21) Appl. No.: 10/360,065

(22) Filed: Feb. 6, 2003

Related U.S. Application Data
(63) Continuation-in-part of application No. 09/497,788, filed on Feb. 3, 2000.

(51) Int. Cl. G06F 17/60

(52) U.S. Cl. 705/39

(57) ABSTRACT

The invention comprises methods and systems for obtaining music and promoting the sale of music using electronic accounts. In one embodiment, a promotional award, such as an award of music or music-related merchandise or points usable to obtain music or merchandise, is created. Information identifying the account is associated with traditional media used to store music, such as an award ticket located in a jewel box housing a music compact disc. A consumer is further enticed to purchase the media in order to obtain the promotional award. The consumer utilizes the promotional account information associated with the media to access the account to obtain the award, such as by logging into a website. In one embodiment, monetary value may be associated with an account to pay for a download of data representing a particular music selection. Accounts or awarded points may be merged to obtain larger awards.

### RELATED APPLICATIONS

This application is a continuation-in-part of U.S. application Ser. No. 09/497,788, filed Feb. 3, 2000.

### FIELD OF THE INVENTION

The present invention relates to the use of accounts to obtain music and to facilitate music promotions including the sale of music and the award of music and music-related merchandise.

### BACKGROUND OF THE INVENTION

A variety of methods and devices are currently available for facilitating the purchase of goods or services and the transfer of money. Some of the devices include cash, checks and credit cards. Some of the methods include by mail or in-person payments and wire transfers. These current methods and devices have numerous limitations, some of which are evident when considering a variety of situations.

One limitation relates to the ability of minors to make purchases. In the past, minors have generally made purchases in cash or check either tendered directly to the vendor at the vendor's location or mailed to the vendor. With the advent of the Internet and telephonic phone orders, consumers are now offered the ability to purchase goods on-line or over the phone, remote from the vendor offering the goods or services. A primary advantage or purchasing goods in these manners is that the time delay associated with mailing an order to the vendor is eliminated. In either case, however, to realize these speed advantages, the customer must tender payment to the remote vendor at the time the order is placed instead of mailing payment to the vendor. As such, nearly all on-line and telephonic purchases are facilitated by use of a credit card. A user places an order and provides his or her credit card information, either directly to a representative of the vendor or via data input on-line. A retailer then uses the card information to receive payment from the authority issuing the credit to the user of the credit card.

Generally, minors do not have access to credit cards. One reason for this is that under the law, minors are not necessarily legally bound to their actions. Thus, a credit issuing authority which issues a card to a 17 year old may find that it can not force the minor to pay any debts incurred by using the card. In addition, parents wishing to teach their children financial responsibility often do not wish to provide cards to their children where they can not monitor and control the expenditures by the child.

ATM or “automated teller machine” cards are available which are linked to a bank account. These cards permit a user to withdraw funds from his or her account, such as at a cash dispensing machine. Some of these cards may also be accepted by retailers, both on the Internet and at the retailer's location. A significant problem with these cards is that they are linked to the user's primary bank account. If the user's card information is intercepted, such as during an on-line transaction, a thief may be able to completely empty the user's primary banking account of all funds. In addition, a user may not even be aware that his or her card has been misplaced or lost for a long period of time during which another party may find the card and access his or her account.

Currently, there is also no convenient means for providing gifts or promotions to consumers which is compatible both with standard retail store and on-line purchasing. For example, a gift giver may travel to a store and purchase a “gift certificate” to the store. The gift certificate comprises a paper check, magnetic striped card or similar item. The recipient of the gift may travel to the store and present the gift certificate to serve as payment for goods. Unfortunately, the recipient of the gift certificate must travel to the store to use it. In many situations, this is undesirable, such as when the gift recipient lives far from the store where it was purchased.

Another problem with gift certificates is that they are limited in their acceptance. Both those who give and receive gift certificates desire the ability to use the gift certificate at a wide variety of locations, permitting the gift recipient maximum latitude in selecting his or her gift. Gift certificates are sometimes available for use at a number of stores at a particular location. These gift certificates are issued by a central authority, such as a mall at which all of the stores are located. These certificates are not otherwise accepted, however.

Another environment having a great number of limitations is the music industry. Currently, online music distribution over the Internet has become a major problem for existing brick and mortar record companies. With the popularity of Napster and peer-to-peer Internet technology and digital download capability, the control of copyrighted material by the copyright owner has become increasingly difficult, if not impossible. Yet, the average consumer would gladly pay a fee for the copyrighted material if there was an easy way to pay for the material desired and to quickly and easily obtain the music by downloading it.

Presently, use of the Internet for distribution of digital music consists of either purchasing a complete CD on an Internet site such as Amazon.com or paying for a monthly service such as mp3.com. A monthly service such as that offered by mp3.com, offers an E-music subscription for $9.99 a month with a 12 month minimum. The subscription provides the subscriber with unlimited downloads of its MP3 catalog.

There are numerous problems with these services. A problem with a system in which a user must purchase an entire selection of music normally published on a single CD is that the consumer is required to pay the price associated with the entire content when the consumer may desired only a small portion of the content. For example, most CDs have approximately 12 songs or tracks. A consumer, however, may only be interested in 2 or 3 of those tracks. In this system, the consumer pays the representative value of all of the tracks to obtain only the 2 or 3 tracks that they are interested in.

Subscription services also have numerous drawbacks. One problem is that the subscriber is limited to digital music catalogs provided by the service. This means an individual may have to pay for numerous services in order to cover all the artists and songs of interest.

Paying for each of these services costs about the same as purchasing a single CD each month. For those months where the subscriber does not find any music of interest, the subscriber still has to pay the monthly fee. A subscriber may pay hundreds of dollars per year for the right to download music from each subscription service. This means that the subscriber must get approximately 10 CDs worth of music each year from each specific service to make it more cost effective than simply going to a store and purchasing the CDs.

It is for these reasons that Napster and similar services have become popular: the consumer has access to a wide variety of content and may obtain specific songs or tracks without having to also obtain content which is not desired. It is desirable to provide one or more methods and devices which serve to facilitate a consumer's desire to obtain specific music via a download service, and a means by which the record industry may promote music and the download service.

### SUMMARY OF THE INVENTION

The present invention comprises one or more methods and apparatus for facilitating financial transactions such as the purchase of music and music related merchandise, and for promoting the sale of music and music related merchandise.

One or more embodiments of the invention comprise a method of a customer establishing an account with an account provider, the account having features particularly useful in facilitating monetary and commercial transactions. This method comprises the steps of providing customer data to the account provider, establishing an account type, assigning a value limit for the account, depositing funds in the financial account in an amount not exceeding the value limit, assigning the account an expiration date after which access to the financial account is generally prohibited by a user, and generating an account signature for use in establishing later entitlement to access the account.

One or more embodiments of the invention comprise an account which is particularly useful in facilitating monetary and commercial transactions. The account has monetary funds associated therewith which may be debited from the account, an expiration date associated therewith after which access to the account is prevented, a maximum funds value comprising the maximum funds which may be associated with the account, and account data for use in establishing entitlement to access the account.

One or more embodiments of the invention comprise a method of facilitating a commercial transaction comprising establishing a financial account, the account having a maximum funds limit, funds associated therewith not exceeding the limit, an expiration date after which commercial transactions are prohibited, and account access data, a customer activating the account in order to utilize the account, determining if the customer wishes to utilize the account to facilitate a commercial transaction, determining if access to the account is permitted if it is determined that the customer wishes to utilize the account, and if access is permitted, and debiting funds from the account in order to facilitate the transaction.

One or more embodiments of the invention comprise a method and system of using accounts to facilitate the purchase of music and to promote the sale of music, especially in traditional format where stored in a physical media.

One embodiment of the invention comprises a method of facilitating the purchase of music contained on traditional media comprising the steps of establishing a promotional account, the account representing entitlement to an award, associating information identifying the promotional account with a media storing data representing music content, selling the media to a consumer, receiving the information identifying the promotional account from the consumer, and awarding the award to the consumer. In accordance with this method, the opportunity to obtain an award via a promotional account is utilized to entice purchase of music stored on traditional media.

In this method, the traditional media may comprise a compact disc (CD). The promotional account information may be printed on a media located inside of jewel box used to store the CD.

The consumer may transmit the promotional account information over a communication link, such as the Internet, to a remote server. In embodiment, the consumer accesses the website and utilizes the account information to obtain the promotional award.

A variety of awards may be provided. In one embodiment, the award is music. Data representing the music is transmitted over the communication link to the consumer. Other awards may comprise physical goods or free or reduced cost services.

In one embodiment, the method includes the step of associating points or other credit information with each promotional account. In accordance with the method, a consumer is permitted to merge account or points to accumulate larger point or credit totals.

In one embodiment of a method of the invention, a first account is created and information identifying the account is distributed to the consumer. In one embodiment, the consumer establishes the account. In another, the account may be set up by a third party, such as a music distributor and the information provided as part of a music purchase.

The method includes the step of associating information regarding purchases of media storing data (such as CDs) representing music by the consumer with the first account. This information may comprise a number of points representing the purchases. In addition, information regarding a number of promotional points awarded to the consumer may be associated with the same account. The consumer may manage and utilize the account. For example, the consumer may redeem the points associated with the account for merchandise or services.

In one embodiment, information representing monetary value may be associated with the account. A consumer may make a funds deposit and utilize the funds information to make a music purchase. Information from other accounts may be merged or moved into the account. For example, promotional account information such as awarded points may be merged into the consumer's account.

One aspect of the invention is a method of facilitating digital music purchases. In one embodiment, the method comprises the steps of establishing a communications link between a first server and a second server at a remote location, identifying a user of the first server, transmitting data to be stored from the first server to the second server via the communications link, associating identifying information regarding the user with the transmitted data, choosing a digital music selection, paying for the music selection with value associated with a financial account, and downloading the music selection from the second server to the first server via the communication link.

In this method, a consumer is permitted to make individual music content selections, such as a single song instead of a CD storing a plurality of songs. The purchase is facilitated by an account having associated value information. An account may be purchased as a gift and provided to another party or a consumer may make a deposit of funds. The associated funds may be utilized to make the music purchase.

Further objects, features, and advantages of the present invention over the prior art will become apparent from the detailed description of the drawings which follows, when considered with the attached figures.

### DESCRIPTION OF THE DRAWINGS

FIG. 1 is a flow diagram illustrating a method in accordance with the present invention;

FIG. 1(a) is a flow diagram illustrating in detail a method comprising a step of establishing an account in accordance with the method illustrated in FIG. 1;

FIG. 1(b) is a flow diagram illustrating in detail a method comprising a step of activating an account in accordance with the method illustrated in FIG. 1;

FIG. 1(c) is a flow diagram illustrating in detail a method comprising a step of determining if access to an account is permitted in accordance with the method illustrated in FIG. 1; and

FIG. 1(d) illustrates various flow diagrams of methods comprising a variety of methods of utilizing an accordance in accordance with the method illustrated in FIG. 1.

FIG. 2(a) is a schematic diagram of a system configuration utilizing financial music accounts.

FIG. 2(b) illustrates one configuration of a system by which a consumer may obtain a specific selection or track of music on-line.

FIG. 2(c) is a schematic diagram of a system configuration utilizing financial music promotion accounts and merchandise distribution.

FIG. 2(d) illustrates how accounts in accordance with the invention may be combined.

FIG. 2(e) is a schematic diagram of a system and associated transactions involving use of consumer, third party and promotional accounts in accordance with the invention to obtain merchandise and on-line music.

### DETAILED DESCRIPTION OF THE INVENTION

The invention comprises one or more methods and apparatus for facilitating monetary and commercial transactions. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises one or more methods and apparatus for facilitating transactions, such as monetary funds transfers and purchases, and especially those occurring at least partially electronically. The invention also comprises methods and apparatus for facilitating commercial transactions, such as the purchase of goods and services.

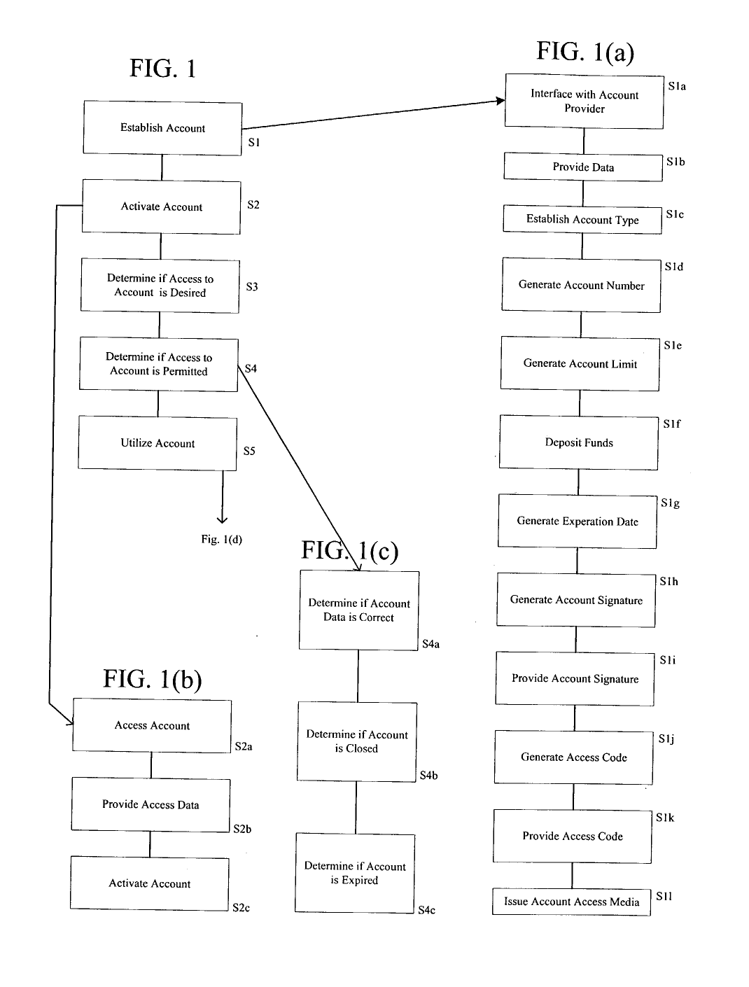

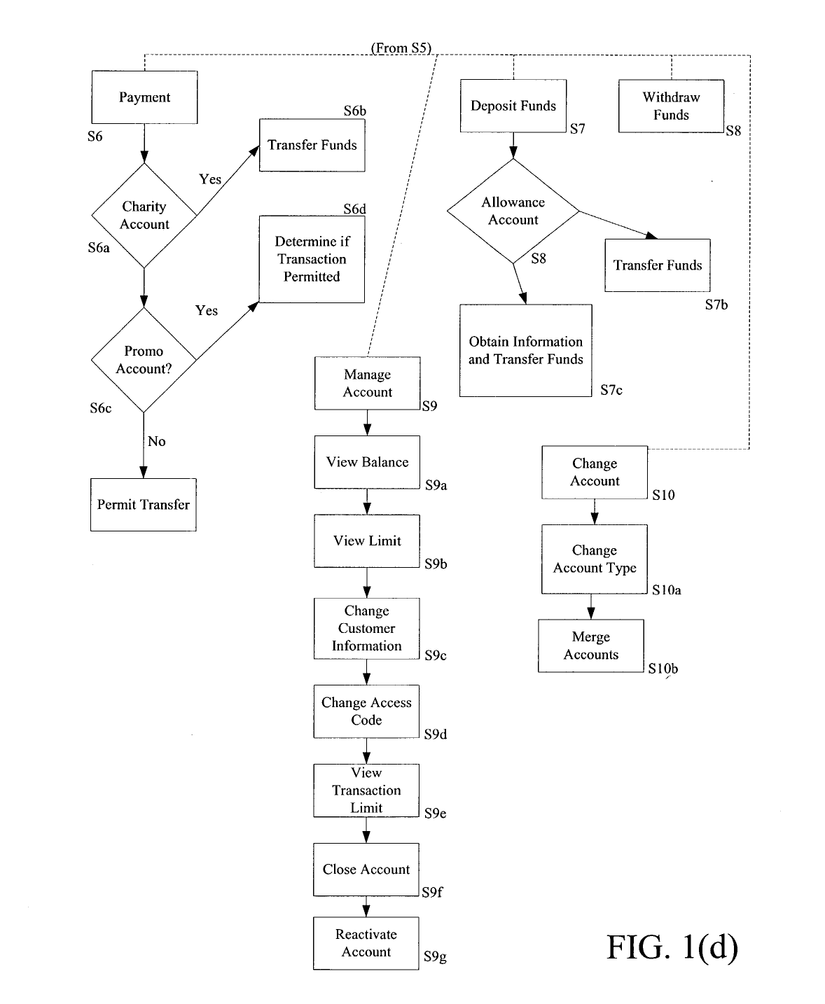

One aspect of the invention comprises the establishment of an account. One or more embodiments of such a method will be described first with reference to FIG. 1. First, in a step S1, an account is established. The account may be established by a party for use by himself or herself or for use by others. As used herein, the person who establishes the account is generally referred to as a customer, regardless of whether that person is establishing the account for himself or herself or another party or user.

The account is established by an account provider. The account provider may be a retailer, bank or other entity. As provided below, regardless of whether the account is referred to as a financial, bank, debit, monetary or other named account, the account has certain characteristics that define it.

Referring to FIG. 1(a) there will be described one or more methods for establishing an account. In a first step S1a, customer interfaces with an account provider. This step may comprise the customer accessing a website belonging to the account provider, calling an account provider customer representative, or accessing one or more other means now known or later developed by which the customer may provide information to the account provider.

In a step S1b, the customer provides data to the account provider. This data is used to set up the account. The particular data which is required may vary by provider. In one or more embodiments, the data may include the customer's name and/or the name(s) of the parties which are to be permitted to access the account, address, telephone number, social security number, birth date, mother's maiden name and/or other information. In the event the customer is a business, the information may comprise the business name, address, telephone number, taxpayer identification number and/or similar information.

The particular manner by which this information is transmitted to the account provider may depend upon the interface the customer is using. For example, the data may be input into a graphical user interface associated with the account provider's website and then sent to the account provider's computer, such as over the Internet. The data may be provided orally over the phone by the customer to the account provider.

In a step S1c, an account type is established. In one or more embodiments, the account type may comprise one or more of the following: customer debit, charity debit, promotional, or allowance account.

A customer debit account is preferably of the type where funds belonging to the customer are assigned or credited to the account, and payments, transfers and the like are associated with debits of these funds from the customer's account. This is opposite to a credit type account where those funds which are debited belong to the account provider or other creditor with the requirement that the customer repay the account provider with his or her funds at a date after a particular transaction. In general, the customer debit account permits a customer to make and pay for purchases, obtain funds (such as currency), and transfer funds into and out of the account.

A charity debit account is preferably of the type where the customer may only transfer funds from the account to an authorized charity or similar entity, with no other debits permitted (except return of the funds to the customer or transfer of funds to another account belonging to another account at the specific instruction of the customer). Generally, the customer will provide the account provider specific information about the charity to which funds are to be transferred. The customer may arrange the account such that funds are debited and transferred to the charity at one or more predetermined times and for one or more predetermined amounts.

A promotional account is preferably of the type where the customer is a promoter arranging an account for use by one or more other parties. For example, the promoter may be a store owner and the parties who may use the account may comprise customers or potential customers of the store. The promotional account is arranged so that the parties or users may access the account in accordance with the terms of a promotion offered by the promoter. A promoter may establish an account having funds permitting a number of parties to pay for a certain dollar amount of goods purchased at its store via the promotional account. For example, a promoter may establish a promotion for a number of parties, such as 1000 existing customers, whereby $10 of each purchase from the promoter over $20 is payed for by the promoter. The $10 payment may be debited from the promotional account at the time each party makes a qualifying purchase to credit the parties' payment of the goods or services.

An allowance account is preferably of the type where funds are arranged to be periodically transferred into the account. Such an account may be extremely useful to parents having children. In accordance with this account arrangement, funds are periodically transferred into the account for subsequent use. The funds may be transferred from another established account, or an account or other source not associated with the account provider. For example, parents may establish a customer account from which funds are periodically transferred, such as every two weeks, into an allowance account which is accessible by one or more of their children. These children may access the allowance account to pay for books and the like. In this manner, the parents may control (and as described below, track) the spending of their children or other parties which have access to the account.

Those of skill in the art will appreciate that the particular type(s) of accounts and their various features or characteristics may be different than those provided above. For example, an account may have one or more features associated with more than one of the account types provided above.

In a step S1d, the account provider generates an account number and associates the account number with the account. The account number may be used by the account provider and customer to identify the account.

In a step S1e, the account provider assigns the account with a maximum funds value or value limit. In general, this value may be selected by the customer. Most often, the maximum value will comprise the amount of an initial deposit into the account by the customer. In one or more embodiments, the account provider may only offer accounts having pre-set limits, such as $50, $100, $250 or $500.

In a step S1f funds are deposited into the account. Preferably, the maximum amount of funds which may be deposited into the account does not exceed the funds maximum value associated with the account.

In one or more embodiments, the customer provides data which permits the account provider to obtain funds electronically. In one or more embodiments, this comprises providing the account provider with a routing number for a checking or savings account at a bank, account and access information for an ATM card linked to an account, or a credit card. In one or more embodiments, a customer may be permitted to deposit funds by mail or similar non or partially non-electronic manner.

In a step S1g, the established account is assigned an expiration date. In one or more embodiments of the invention, this step comprises associating date data with the account. The expiration date may be generated in a wide variety of manners. The expiration date may comprise a date which is determined by adding a fixed period of time to the date on which the account is established or, as described below, the date on which the account is activated. As described below, the account is arranged such that when the actual date reaches the expiration date, the account can not be accessed except by the account provider.

In a step S1h, an account signature is generated and associated with the account. The signature comprises a unique code or other element for establishing entitlement to access the account. In one or more embodiments, the account provider generates the code based on one or more elements of data associated with the account, such as customer provided data, the initial funds deposit amount, the account number, the account expiration date and/or one or more other elements. In one or more embodiments, the account signature is generated from, or includes, an access code or personal identification number (PIN) data assigned to or selected by the customer as described below. In one or more embodiments, the data used to generate the signature may be input into an encryptor to generate an output which comprises the account signature. The account signature may be generated randomly as well. Preferably, whatever means is used to generate the signature, each signature is unique for a particular account.

In a step S1i, the account signature is provided to the customer. In one or more embodiments, the account signature is mailed to the customer, told over the phone by a customer representative of the account provider to the customer, or is transmitted electronically to the customer. As described below, in the event the customer is provided with an account access media, then the account signature may be provided on the account media. The account signature may be printed on, embossed in, or encoded on the account media or an element associated therewith.

In a step S1j, an account access code is generated and associated with the account. In one or more embodiments, the account provider generates the access code. In other embodiments, the customer generates the code and provides it to the account provider. The access code may comprise a personal identification number or “PIN” comprising one or more letters and/or numbers.

In a step S1k, the access code is provided to the customer. In the case where the customer selects the access code, this step is completed at the same time as step S1h. When the account provider generates the code, the code may be mailed, electronically transmitted or spoken to the customer.

In a step S1l, in one or more embodiments, the customer is provided with an account access media. The access media may comprise a card, check, ticket, chip or a wide variety of other items. In one or more embodiments, the account signature is associated with the access media. When the access media comprises a card, check or the like, the account signature and/or account may be printed or encoded thereon. The account signature may be provided in one or two-dimensional bar code form or be encoded in a magnetic stripe or a chip or other data storage element associated with the media.

The account signature and/or access code may comprise a physical characteristic of the customer. For example, the access code may comprise a fingerprint or the customer's retinal features. In general, the account number, signature and access code are for use in identifying the particular account and ensuring that only those parties with authority to access an account can do so. A variety of other methods and devices may be used for these purposes.

A variety of other steps and may be associated with the establishment of an account for the customer, and the steps described above need not be completed in the order in which they were described.

Referring again to FIG. 1, in a step S2, an account which the customer wishes to access is activated. Normally, this step will be in response to a customer wishing to access a newly established account.

Referring to FIG. 1(a), there is illustrated one embodiment of a method of activating an account in the event the account has not been activated. In a first step S2a, the customer accesses the account. In one or more embodiments, this step comprises a customer contacting the account provider, such as via a website of the account provider or by telephone with a customer service representative.

In a second step S2b, the customer provides his or her account number, signature and, in one or more embodiments, the access code. This account identification and access data may be provided by a customer telling an account representative the information, typing the information into a data input accepting element of a graphical user interface of a website, or otherwise transmitting such to the account provider. In one embodiment, the account number and signature may be scanned off of an account media provided the customer, such as with a magnetic stripe or bar code reader.

In a step S2c, the account provider activates the account. In one or more embodiments, this step comprises associating data with the account which indicates that the customer and/or other designated and/or appropriate parties may utilize and access the account.

The account activation may be accomplished in a wide variety of other manners. For example, in one embodiment, a customer may activate an account by simply calling a phone number of the account provider or entering the appropriate data into the account provider's website. In this arrangement, it is not necessary for the customer to access the account or to provide all of the account information which may be necessary for the customer to use the account.

In one embodiment, an account may be activated for use by a customer at the time it is established. In such an arrangement, any access media associated therewith may be separately activated. For example, the account may be activated when established, allowing a customer to make deposits, funds transfers or the like through an account provider representative or website. However, the customer may not be permitted to utilize an account media (such as for purchases or cash withdrawals) until the customer activates the account as to the media. The customer may activate an access card by calling a representative of the account provider after the card is received or other means.

Referring again to FIG. 1, in a step S3 it is determined if a customer wishes to access an account, as by a customer's attempted use of the account. This step may be remote in time from step S2, or at the same time. For example, a customer may activate an account shortly after establishing it, but not access the account for several days or weeks thereafter. A customer may also wish to activate an account and utilize it at the same time, such as when the customer wishes to pay for a purchase at a store.

In one or more embodiments, this step comprises determining if a customer is accessing a bank, automated teller, customer service representative, account provider website, remote payment station or the like. In order to determine if the customer is attempting to access an account, particular account information and associated access data is required. This data may be provided to the account provider or other account access controlling entity in a number of manners. In one or more embodiments, the account information may be directly provided by the customer, as through data input into a website or spoken to an account representative, or by reading the information from the access media.

The customer may wish to access the account for a number of reasons. For example, in the event a customer wishes to complete a purchase from a vendor, such as on-line or at a store, the customer may seek-to access the account to pay for the purchase. The customer may seek access to the account to obtain funds from an automated teller machine.

In one or more embodiments, data must be provided to the account provider to establish the entitlement of the customer to access the designated account. This information may comprise the account signature and/or access code. Again, the particular means and/or method by which this information is provided may vary. In an embodiment where a customer is seeking to access an account using an access media, the account signature may be read or scanned from the card, and the access code may be provided by the customer, such as through a keypad. The customer may also provide such information through a variety of data input devices, such as a computer or customer station at a store, or provide the information directly to an account representative.

When a customer wishes to access an account, in a step S4 it is determined if the access to the account is permitted. In one or more embodiments, and referring to FIG. 1(c), this step includes a step S4a of determining if the provided account access information is correct and complete. In one or more embodiments, this step comprises comparing the provided account identification and/or access information to that associated with the account which the customer is seeking to access. If the required information has not been provided or is not correct, access to the account is denied. The customer may then be directed to contact the account provider and/or attempt to re-enter the required data in case there was an error in providing or transmitting it to the provider.

If the requisite access information is provided, then in a step S4b, it is determined if the account is closed. If the account has been closed, then access to the account is denied. The account may be closed at the request of the customer, upon violation of account terms and conditions or for a wide variety of other criteria or reasons.

If the account is not closed, then in a step S4c, it is determined if the account is expired. The account may be determined to be expired if a current date is the same as or time-wise later than the expiration date assigned to the account. If the account is expired, the customer is not permitted to access the account directly. Preferably, in that situation, the customer may access the account only through the account provider. The customer may contact the account provider and arrange for the removal of any funds remaining in the account. Alternatively, the customer may be permitted to re-activate the account with a new expiration date.

If in step S4 it is determined that access is permitted to the account, then in step S5, the customer is permitted to utilize the account. As described below, a variety of transactions, interactions with and manipulations to the account are permitted.

Referring to FIG. 1(d), in one or more embodiments, in a step S6, a customer is permitted to utilize the account to make a payment to a third party. A variety of methods may be implemented to effectuate this step. In one or more embodiments, in a step S6a, it is determined if the account is a charity account. If so, in a step S6b, funds are transferred from the charity account to a selected charity.

In one or more embodiments, when a charity account is established, the account provider designates the account as a charity account. At that time, a customer may designate one or more charities to which funds placed in the account are to be distributed to. These funds may be distributed in accordance with the specific instruction of the customer at a later date, or at a predetermined time or in accordance with a predetermined schedule. The amount of the funds to be distributed may be designated by the customer as well. In one or more other embodiments, the customer may designate the charity(ies) to which funds are to be distributed after the account has been established.

In one or more embodiments, the funds which are distributed to the charity are transferred electronically from the account by the account provider to an account belonging to the charity or an intermediate escrow account or the like from which the charity may obtain payment. In other embodiments, the funds may be mailed or transmitted in other manners.

If the account is not a charity account, then it is determined in a step S6c if the account is a promotional account. If the account is a promotional account, then in a step S6c, the account may be used to purchase or pay for goods from specific parties. Preferably, the account provider must verify that the purchase is being made from one of the authorized parties. Normally, when the purchase is being made, the vendor will transmit vendor identification information along with the customer's account information. The account provider can verify the vendor from the provided vendor information.

If in step S6c it is determined that the account is not a promotional account, then it is determined that the account is a customer or allowance account which may be used as the source of payment for a transaction with, in general, any party. In step S6e, the purchase or other transaction is then facilitated by debiting the account.

It will be appreciated that a variety of steps other than those described may be associated with the payment of a purchase from the account. For example, in one step, the account provider must generally verify that sufficient funds exist in the account to permit the transaction. If sufficient funds do not exist, then the transaction may not be permitted. Alternatively, as described below, the account may be provided with a “credit” or “overdraft” feature which would still permit the customer to access the account.

As part of the transaction, the particular vendor may send information which facilitates the transfer of funds from the customer's account to the vendor's account by the account provider. For example, this information may comprise a vendor identification or account number.

As provided above, the method and apparatus by which the customer accesses the account to facilitate a purchase may vary. For example, if the customer is purchasing goods at a store, the customer may swipe his or her access media through a card reader and enter his or her access code. If the purchase is through a web-site or similar on-line access, the data may be input into a graphical user interface of the site.

In accordance with one or more embodiments of the invention, the payment for purchase may be arranged as an automated debit from the account. For example, a customer may arrange for payments to be made from the account on a periodic basis, such as in response to monthly amounts due a party (such as for a car payment or the like). In such event, the customer may provide the necessary debit information to the account provider.

In one or more embodiments, a purchase may be made in the form of an automatic funds transfer. For example, a customer may arrange with a particular vendor an arrangement where payment for the goods or services is made automatically. The customer provides the vendor with the account data which is then used by the vendor at one or more times subsequent thereto to effect payment. As an example, a customer may provide account data to his or her electric company. The electric company may then receive payment for the electricity supplied to the customer each month directly from the account through the account provider without intervention by or acts required by the customer. In this embodiment, the step of the customer accessing the account, step S3, generally comprises the customer providing the account data to the vendor or other party and then the vendor accessing the account as agent of the customer.

As one aspect of utilizing the account, as illustrated in FIG. 1(d), in a step S7 in one or more embodiments, a customer may deposit funds into the account. A variety of methods may be implemented to effectuate this step. In one or more embodiments, this step includes a step S7a of determining if the account is an allowance type account. If so, then in a step S7b, funds are periodically transferred into the account. If the account is an allowance account, a customer will have provided the account provider with a source of funds from which a transfer into the account is to be made. The source of funds may be a customer's credit card, a bank account, or another account in accordance with the present invention. The customer will also have provided the account provider with specific instructions as to when funds are to be deposited, in what amount and the like.

If the account is not an allowance type account, then in a step S7c, the customer must specifically arrange for the particular transfer of funds with the account provider. For example, the customer may access a web-site or customer representative and provide source funds data. This data may comprise credit card information, bank account and routing information or the like. The customer may also arrange for funds transfer between accounts at a bank or similar provided customer station, phone controlled system or the like.

As one aspect of utilizing the account, as illustrated in FIG. 1(d), in a step S8 in one or more embodiments, a customer may withdraw funds from the account. A variety of methods may be implemented to effectuate this step. In one or more embodiments, the funds withdrawal may comprise the issuance of currency such as U.S. or other dollars, or other media. In one or more other embodiments, the withdrawal may comprise the transfer of funds to another entity or account.

In general, when the customer desires to obtain currency, the customer travels to an automated teller machine (ATM), bank or similar currency dispensing location. In such event, the step of providing the requisite account data (see step S3) may comprise swiping an account media and inputting an access code. In the event the customer does not have an access media, the customer may provide the requisite data directly to a teller or other bank personnel for input into a system.

If the customer desires to withdraw funds and have the funds transferred into another account, the customer may be permitted to do such over the phone, via the account provider's web site, or at a bank or other location. In this regard, the number of locations at which a customer may effectuate the transfer is not constrained to locations where currency can be dispensed.

If the customer requests funds, and if such funds exist in the account, the customer is provided with funds. This step may include the step of transmitting the fund request to the account provider and the account provider comparing the amount of funds requested versus the total amount of funds in the account. If the funds exist, then the account provider may send a signal or other indication that it is permissible to dispense the funds.

In one or more embodiments, the customer is permitted to request currency or a transfer. If currency is requested, then currency is dispensed. If a transfer is requested, then the funds may be transmitted electronically to a new account. In the event the funds are to be transferred to another account, the customer provides the necessary information, such as the receiving account number and/or routing number and/or receiving party information.

As one aspect of utilizing the account, as illustrated in FIG. 1(d), in a step S9 in one or more embodiments, a customer may obtain account information and manage his or her account. A variety of methods and devices may be utilized to effectuate this step. For example, a customer may call an automated telephonic information system, call a customer service representative or access a web site belonging to the account provider. In one or more embodiments, certain information and transactions may be permitted through an automated teller machine or similar remote access site.

In one embodiment, this step may include one or more of the following steps. In a step S9a, a customer may be permitted to obtain his or her account balance. The account balance may be provided on a viewing screen or printed on paper.

In one or more embodiments, in a step S9b, a customer may obtain the account limit for his or her account. The limit value may be displayed to the customer if the customer is located at a display, or may be printed onto a media, such as paper, and dispensed or mailed to the customer. If the customer is utilizing a phone system, the information may be transmitted over the phone.

In one or more embodiments, in a step S9c, a customer may change information associated with his or her account. This information may comprise his or her name, address, telephone number, the name(s) of parties permitted to access the account and the like.

In a step S9d, a customer may change his or her access code or similar access information. For example, in one embodiment, the account provider may assign the customer the access code when the account is established. In accordance with this step, the customer may change this access code to a code of his or her selection.

In a step S9e, a customer may obtain information regarding transactions associated with the account. This information may include information regarding fund deposits, withdrawals and other transactions. In one or more embodiments, the customer may obtain information regarding an amount paid or transferred out of the account, the date of the transfer and the party to whom the amount was paid or transferred. The customer may obtain information regarding an amount deposited or transferred into the account, the date of the transfer and the origin of the funds.

In a step S9f, a customer may close the account. When closing the account, the customer may indicate to the account provider the location to which any funds remaining in the account are to be transferred.

In a step S9g, a customer may re-activate an account in order to change its expiration date. For example, before an account expires, a customer wishing to utilize the account for a longer period of time may elect to re-set the expiration date for the account. In one or more embodiments, the date is automatically set by the account provider, such as by adding a period of time to the current expiration date or the current date. In one or more other embodiments, the customer may select a new expiration date in the future.

As one aspect of utilizing the account, as illustrated in FIG. 1(c), in a step S10 in one or more embodiments, a customer may change the status of the account. A variety of methods may be implemented to effectuate this step. In a step S10a, a customer may change the account type, such as from a customer account to a charity or other account, or vice versa. In a step S10b, a customer may merge one account with another account. For example, a customer having two accounts may wish to merge the accounts into a single account. A customer having one account may establish another and then merge or eliminate the first account in favor of the second.

Several examples of account merging are provided below:

John Doe's Debit Accounts

| Account Type | Balance | Status |
|---|---|---|
| $250 Debit Account | $100 Remaining | Active until Jan. 1, 2001 |
| $150 Debit Account | $50 Remaining | Active until Apr. 1, 2001 |

After merging accounts into a new account:

John Doe's Debit Accounts

| Account Type | Balance | Status |
|---|---|---|
| $250 Debit Account | $0 Remaining | Closed |
| $150 Debit Account | $0 Remaining | Closed |
| $150 Debit Account | $150 Remaining | Active until Jun. 1, 2001 |

Alternatively, the owner of the accounts may wish to transfer the $100.00 remaining from the $250 account into the $150 account with $50.00 remaining. This would close the $250 debit account and establish a new balance of $150 in the $150 debit account. An example of this transaction is as follows:

John Doe's Debit Accounts

| Account Type | Balance | Status |
|---|---|---|
| $250 Debit Account | $100 Remaining | Active until Jan. 1, 2001 |
| $150 Debit Account | $50 Remaining | Active until Apr. 1, 2001 |

After transferring the remaining amount into the $150 account:

John Doe's Debit Accounts

| Account Type | Balance | Status |
|---|---|---|
| $250 Debit Account | $0 Remaining | Closed |
| $150 Debit Account | $150 Remaining | Active until Apr. 1, 2001 |

A customer may also be permitted to close the account. If the account is empty, the account is simply closed by the account provider so that further access to the account by the customer is prevented. In the event funds exist in the account, the customer may be provided with the option of transferring the funds to another location or account or obtaining the funds from the account provider by mail.

In accordance with one or more embodiments of the invention, the account provider may provide a credit line or “overdraft” protection for the account. This option may be provided to the customer for free or upon payment of specific service charges. In accordance with this embodiment, in the event a customer wishes to withdraw funds from the account (whether to obtain currency, transfer to another account or payment for goods/services) in an amount greater than that which exists in the account, the account provider may supply the funds to the customer.

In one or more embodiments, the account provider may charge the customer a specific fee for utilizing the credit line, such as a per usage fee, interest or the like. In one or more embodiments, after a particular transaction which exceeds the amount of funds in the account, the account is frozen until sufficient funds are placed in the account or provided to the account provider to cover the funds deficiency.

One or more embodiments of the invention comprise apparatus for use in performing the above-described methods. As stated above, this apparatus may include an access media, such as a card, check, chip or the like. The apparatus may also include a wide variety of devices for interacting with the account provider and/or account. These devices may include some existing devices, such as existing bank teller machines, card reading devices, and data receiving and transmitting devices.

In one or more embodiments, a customer is permitted to establish and interact with his or her account via a website or similar on-line access. The website may include a graphical user interface designed to provide information to the customer and prompt and accept that information. The website may have multiple levels or pages. For example, the website may have a home page or “log-in” page which prompts a customer to either identify that they are a new customer and wish to establish or activate an account or identify himself or herself as an existing customer and have him or her provide the requisite account information.

If the customer is a new customer, the customer may be sent to a webpage at which information is provided to the customer about the various accounts which may be established. This or other pages may include prompts for providing the data necessary to establish an account.

If the customer is an existing customer and provides the necessary information to access the account (as in Step S3-S5 set forth above), then the customer may be presented with a menu page. At this page the customer may be selected with a menu of items from which to select. These items may be similar to those of steps S7-10. For example, a customer may be provided with a “manage account” item. Upon selecting this item, the customer may be presented with a number of sub-menu items. These items may comprise those items identified in steps S9a-f.

In one or more embodiments, a webpage may display account information for more than one account belonging to a customer. A variety of means may then be presented to the customer for use in manipulating these accounts. For example, a customer may then be permitted to “drop and drag” funds or the like from one account to another.

In one or more embodiments, the account provider has one or more devices adapted to store account information and receive and transmit account data, data representing funds transfers and the like. The account provider may have a system which includes a data storage device, a data input device and a data transmitting device. The data storage device may comprise one or more hard drives or similar elements used to store account data. Modems, servers or similar devices may be used to transmit and receive data. This system may include one or more processors arranged to process data.

The devices used to implement the present invention may be incorporated into existing systems facilitating monetary and commercial transactions. For example, the access media associated with an account in accordance with the present invention may be utilized with current card-reading devices.

In accordance with one or more embodiments of the invention, an account provider may issue accounts associated with access media which are available for purchase by customers. For example, an account provider may associate an account with an access media. The access media may have associated therewith an expiration date, account data and a maximum value. A customer may “purchase” the account and associated access media at a retail location. When the account provider is a bank, the bank may place access media on sale at retail locations such as grocery and retail stores.

A customer purchases the account and card by paying the retailer (who in turn pays the account provider). In one or more embodiments, the customer may thereafter access the account by activating the account. This may comprise calling the account provider after purchase. At that time, the account provider may provide the customer with an access code for use in using the access card. The access code could be provided on the card, but this arrangement has added security in that the account provider can ensure that the account is only accessed once it has been paid for.

In this embodiment, a customer may conveniently obtain a “pre-paid” account for himself or herself or for another party. The account may be used in similar fashion to a credit or ATM card, permitting purchases from any vendor and permitting access to cash from any of a variety of cash-dispensing locations.

It will be noted that in this embodiment, the step of establishing the account is generally accomplished by the account provider without input from the customer. In one or more embodiments, after purchasing or obtaining the access card, a customer may be required or permitted to provide additional information in order to access the account.

It is preferred that the access card indicate the expiration date of the access media. If the access media and associated account is expired, the purchase is not permitted. If the access media is about to expire, the customer may purchase it and, if the customer wishes to extend the expiration date, contact the account provider after purchase to do so. In one or more embodiments, the expiration data may not be printed on the access media, but when it is purchased scanned, read or the like by the vendor to ensure that it is still valid. When a purchase of an access media is made, the expiration data may then be reset a predetermine time from the purchase, with this information scanned onto the card or otherwise associated with the account.

In the above-described arrangement, each access media, once paid for, generally has the same characteristics as cash. A customer may pay for goods using the purchased access media. A customer may deposit the funds associated with the access media into another account, or transfer it to another party.

The present invention has numerous benefits and advantages. First, an account of the present invention is configured to permit minors to make financial transactions. In accordance with the invention, a debit account is established by or for the minor. Because of the existence of the funds in the account, a minor may complete a transaction without concern to the account provider/financial institution that the minor will pay for goods.

In one or more embodiments, this arrangement permits a customer to “buy” an account for use by another person in a fixed amount. In this manner, the account may be used as a gift. This arrangement has the advantage that the recipient of the account can utilize the funds associated with the account to make a purchase or pay for goods/services from essentially any location. The recipient may purchase goods on-line or at a store. The recipient is not limited to a particular store or mall.

The customer may also utilize one or more of the accounts in similar fashion to travelers checks. Because the funds associated with the accounts are different, a loss such as by theft of a single access media does not affect the remaining funds. For added security, each access media may have a different access code.

Parents and others may arrange an account for their children. The children are not permitted to spend more money than their parents provide, because of the arrangement of the account. On the other hand, the parents can provide their children with a convenient means for paying for items even though they may be located a great distance apart. The parents may also access the account to track purchases and other transactions by their children. The parents may also arrange the account as an “allowance” account, where funds are placed into their children's account at predetermined intervals without specific action by the parents or children at the time of each deposit.

The methods and accounts of the present invention has several safety features. Because the account expires after a predetermined time, the risk that a thief may find and be able to use a lost access card is reduced. The account is associated with a unique account signature which is generated from data which is difficult to obtain.

The methods and accounts permit a wide range of transactions, including a number of very specific transactions which are not presently facilitated. For example, a vendor may establish promotional accounts for current and potential customers. One advantage of a promotional account is that a large company may establish accounts which customers can use at one or more of its stores located in different areas. For example, a retailer having outlets in Los Angeles and New York may issue cards associated with accounts for use by customer at either location. This arrangement is also advantageous for franchisees: the franchiser may sponsor a promotion for its franchisees whereby the discount or amounts provided to the customers are paid for by the franchiser.

A promotional account may also be a prize or award. A vendor may award an account to one or more customers who win a contest or drawing or the like. A vendor may also arrange the promotional account with an expiration date requiring the customer to utilize the account within a predetermined time.

A customer may establish a charity account for himself or herself, or a charity may establish an account for a customer. For example, a charity may seek donations from customers in the form of deposits into a charity account established by the charity for the customer.

In one or more embodiments, a customer or other user of a promotional account may be prevented from any account activities except use of the account to facilitate a purchase. The customer or user to whom the account is issued may be prevented from obtaining funds from the account (such as cash) or viewing data associated with the account such as the remaining balance or the like. A customer may also be prevented from merging the account or adding funds to the account. On the other hand, a vendor may be permitted to track all purchases and other uses of promotional accounts. In this manner, the vendor can obtain important data regarding the customer, including his or her spending habits, spending locations and similar information.

A business may use the account for business to business transactions. For example, a business may set up a master account and a number of sub or allowance accounts. The business may use the accounts to pay suppliers of goods and services. The master account may comprise a main account for the business and each allowance account an account relating to a particular vendor or project. Commensurate with billing or an accounting period, the business may have arranged an automatic transfer of funds from the master account to one or more of the allowance accounts, and from one or more of the allowance accounts to each particular supplier for its bill.

One embodiment of the invention comprises a method and system for facilitating the purchase of music and similar content, and obtaining that content. In general, the method and system permits a consumer to purchase specific music content and download data representing that content over a computer network. In one embodiment, the method and system include the use of accounts such as described in detail above. An additional aspect of the invention is the use of accounts, including financial and promotional accounts, to facilitate obtaining music content.

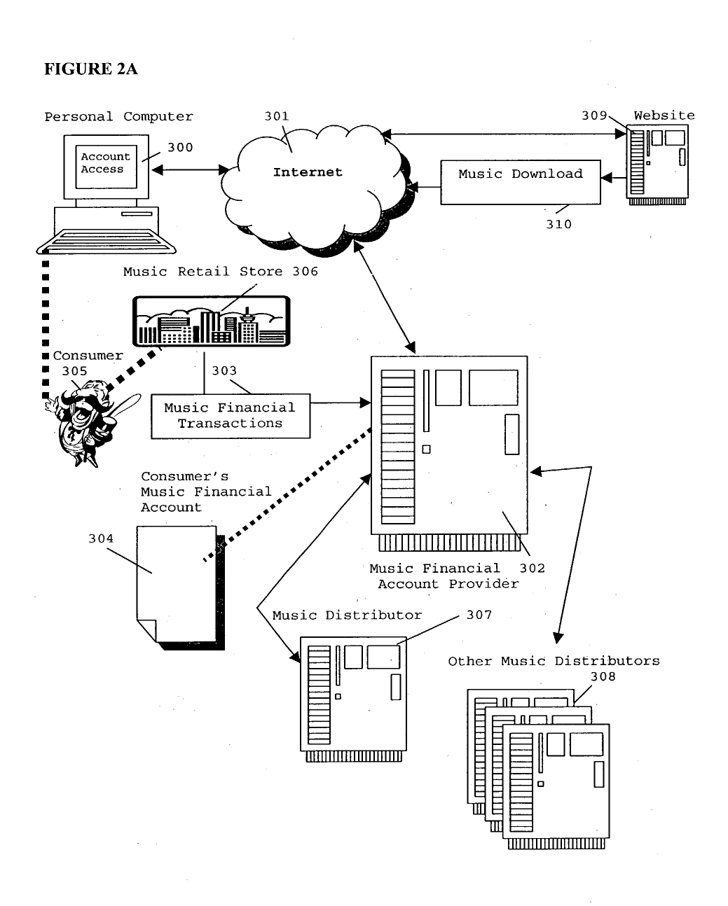

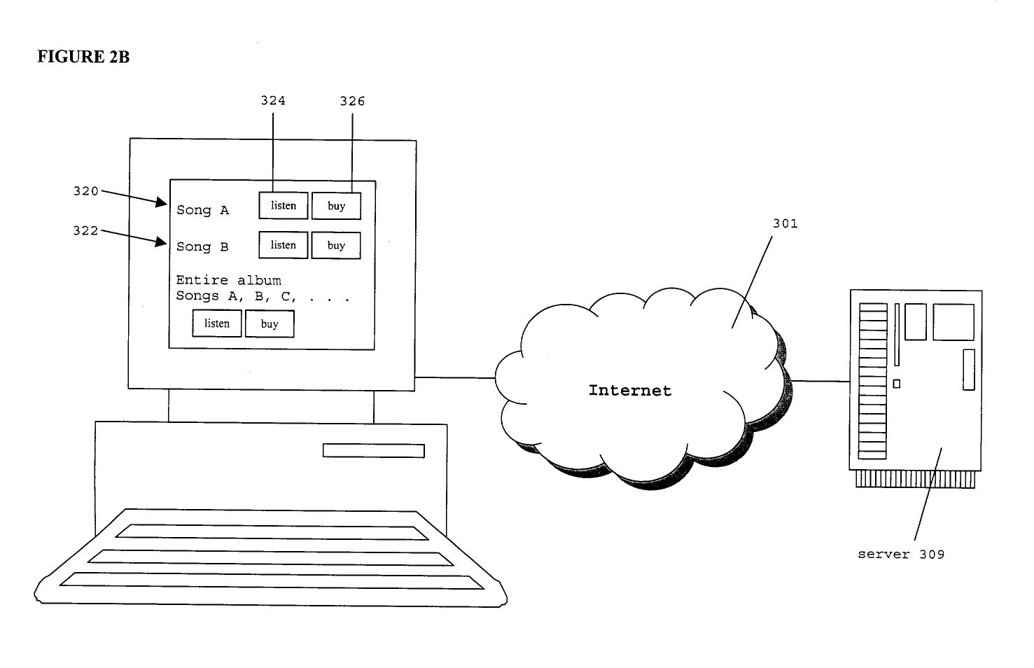

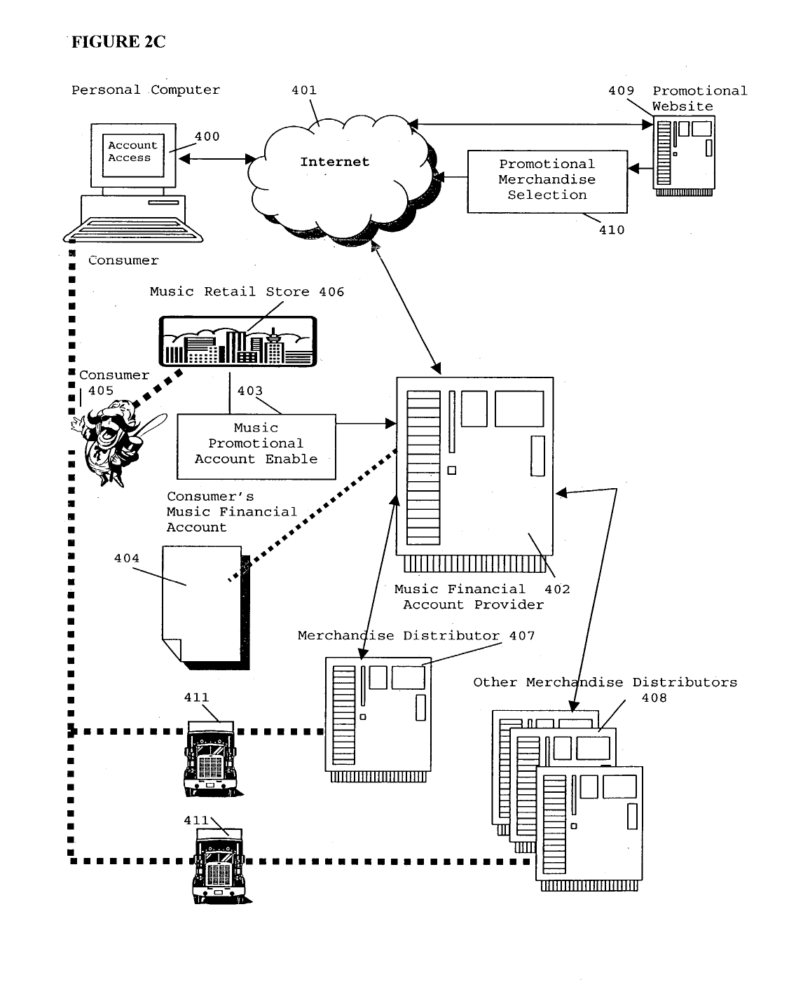

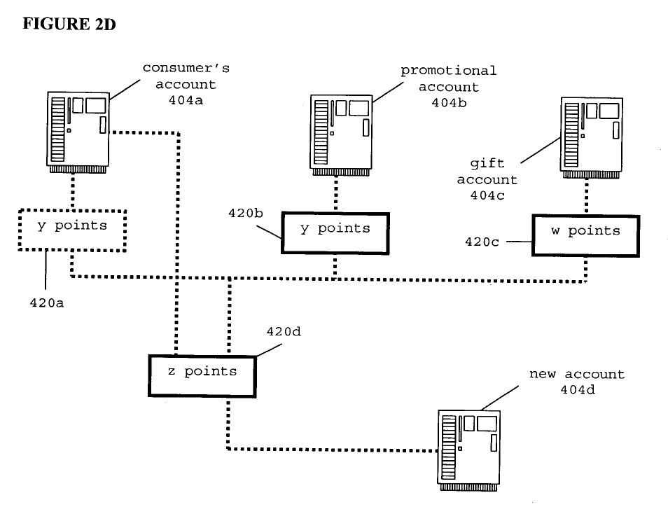

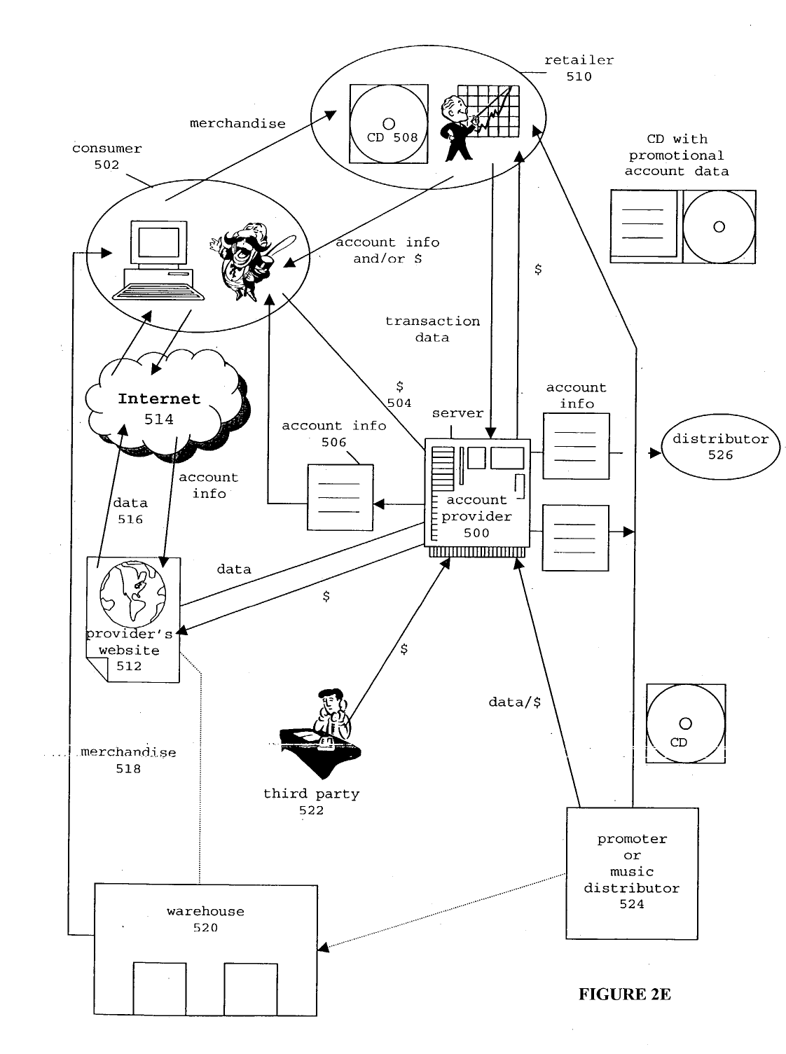

One embodiment of the invention is a method of obtaining music. In accordance with a method, a consumer establishes a communication link with a music source. This may comprise, as illustrated in FIG. 2(a), the consumer establishing a communication link from a computer 300 to a music provider, such as a computer server hosting a website 309. In one embodiment, the communication link is via the Internet 301. Other methods may be used, including direct telephone link dial-up.

Preferably, the consumer is entitled to select from a plurality of music selections. For example, the music provider website 309 may include a menu of musical program selections. Upon selection, the consumer is preferably entitled to hear the music corresponding to that selection for no charge. In accordance with the method, the consumer selects a music program. Preferably, a stream of data representing the music is transmitted from the website 309 back to the consumer's computer 300. The consumer's computer 300 uses the data to generate the music, in a method which is well known. In one embodiment, the consumer is not permitted to store or re-use the data, but is only permitted to utilize the data to generate the music in a single-use “preview.”

In one embodiment, a consumer may also make a music selection without previewing the music. For example, a consumer having heard a song on the radio may desire to obtain the content without previewing it . If the consumer likes a selection, whether previewed or not, the consumer is preferably entitled to purchase the music. The method includes the step of the consumer paying for the content. Once the content has bee paid for, the method includes the step of transmitting data representing the music content to the consumer. Preferably, the consumer is permitted to store and utilize the data to generate the music. The data may include copy protection to prevent unauthorized duplication.

The consumer may select music to purchase in a variety of manners, as is known in the art of e-commerce. For example, the music provider website 309 may permit the consumer to establish a “cart” or may provide for purchase buttons.

Regardless of the selections and the manner by which the consumer is permitted to purchase the music, in a preferred embodiment the consumer is permitted to make specific selections of individual songs or content. In other words, a consumer is preferably not obligated to purchase a combination of music selections, such as the current configuration of the music CD. Instead, the consumer is permitted to purchase individual musical works. FIG. 2(b) illustrates such an arrangement. As illustrated therein, the consumer's computer has been caused to display website information which includes a list of individual songs 320, tracks, pieces or other selections which the consumer may select. The consumer may also have the opportunity to purchase grouped music 322, such as songs or tracks grouped and traditionally marketed in physical media such as a compact disc (CD). As illustrated, in one embodiment, the consumer is provided with the option to listen to 324 or purchase 326, such as by downloading, the desired music.

The consumer may effect payment for the music in a variety of manners. For example, the consumer may utilize his or her credit card or a debit card to pay for the content. In a preferred embodiment, however, the consumer utilizes an account, such as a financial, allowance, gift or promotional account such as that described above to effect the purchase. One or more aspects of the invention thus comprise the use of an account in order to obtain music content.

In one embodiment, the financial account may strictly be a monetary account such as a debit or allowance account described above. Once the account is activated, the consumer may utilize the account to purchase music content. In the case of a debit account, for example, the consumer may fund the account and then utilize monies associated with the account to pay for specific music content which the consumer desires.

The consumer may utilize an account which has been assigned or given to him or her in order to obtain the music content. For example, parents may set up a debit or allowance account for their child or the account may be provided as a gift, such as a birthday present. As described above, such an account may be utilized by a party who, in other circumstances might not be permitted to make a purchase. For example, an underage purchaser may utilize a debit or allowance account set up for him or her to make a music purchase even though the purchaser would not be entitled to utilize a credit card.

In one embodiment of the invention, promotional accounts such as those described above are utilized to provide consumers with music or music related goods and services. In one embodiment, promotional accounts entitle consumers to obtain, such as by downloading, music content.

In one embodiment, funds, credits or specific music content is associated with a promotional account. In the case of funds or credits, the recipient of the promotional account may utilize the funds or credits to obtain music content selections. In the case of specific music content, the recipient may utilize the account to obtain the specific content which is associated with the account. For example, a music distributor may desire to permit consumers to download a new song by a particular artist. The promotional account may entitle the consumer to download that particular song but not general selections which the consumer desires.

A promotional account may be provided to a recipient in a variety of manners. As described above, the promotional account may be set up by the provider. Evidence of the award of the account to the recipient may be provided by distributing a card, by email or a variety of other means. Generally, the evidence includes notification of the award of the account as well as the access code or other information which is necessary for the recipient to access or utilize the promotional account.

One example of a method of the invention will be described with reference to FIG. 2(a). In accordance with the method, an entity such as a music distributor 307 establishes a promotional account 304 with a provider 302. The provider may be the music distributor, a division thereof, or a separate entity, such as including a financial institution.

The recipient is awarded the account, such as by distribution of an account card. The card includes account access information. The recipient accesses a music content website 309 via the Internet 301 or other communication link. The recipient utilizes the account information to establish entitlement to music content. As described, this may comprise using funds or credits associated with the account to pay for selected music content, or may comprise entitlement to specific content. Once entitlement to the content is established, then data representing the music is downloaded 310 to the recipient.

In one embodiment, as illustrated in FIG. 2(a), evidence or award of the promotional account may be by purchase of goods at a traditional retail music store 306 or by give away promotion at the store or other means. In this manner, the consumer is enticed to travel to the store 306 to purchase music in traditional media format.

In a preferred embodiment, information identifying the account or permitting access or use of the account is associated with the media. In one embodiment, account access information is printed on an insert which is located in the packaging of the media. The information may be printed directly on the media or associated with the media in a variety of other manners. The information may be stored in other than human-readable form, such as in the form of a readable bar-code or in a smart card format. As one example, a promotional account insert including printed promotional account information is located inside of the jewel box holding a CD media.

The promotional account information may comprise a variety of other information. For example, the information may include information regarding how to access and utilize the promotional account. Where a consumer is permitted to access a website to obtain awards, the information may include the website address. The information may also include an account access code which is unique to the promotional account.

Of course, because of the value associated with the promotional account, access to the promotional account information is preferably protected. For example, it is desired that consumers browsing purchases in a store not be permitted to gain access to the promotional account information. Instead, it is preferred that access only be permitted upon specific circumstances, such as upon confirmation of the purchase of the media. As indicated, for example, the account information may be stored inside of a sealed jewel case containing a CD, preventing access to the information until after a consumer has purchased the media and is entitled to unseal the jewel case.

In one embodiment, a consumer's purchases may be tracked with transaction data 303. The data may be used to award the consumer 305 a promotion. For example, a consumer who purchases specific music at a store, frequents a store a certain number of times or the like may be awarded a promotional account. A variety of criteria may be applied to the transaction data 303 to determine when an account is awarded.

In this configuration, a music retailer may store or transmit to a remote location consumer purchase information. Preferably, this information includes consumer identifying information so that it can be ensured that a later award is provided to that consumer and not another party.

Additional aspects of the use of a promotional account will be described with reference to FIG. 2(c). As described briefly above, in one embodiment, consumers may be enticed to purchase traditionally packaged music content, such as a compact disc (CD), tape or other physical media containing the music.

In particular, music distributors establish one or more promotional accounts 404 with an account provider 402. A consumer 405 is enticed to purchase the CD or other traditionally packaged music at a retail store 406 or other source, such as an on-line or “e” business. When the consumer obtains the CD or other physical media, it includes promotional account information. The consumer utilizes that account information to, as described above, obtain music content, such as from a website 409 via the Internet 401.

In one embodiment, the promotional account may entitle the consumer to goods or services other than music or music content. For example, the promotional account may entitle the consumer to merchandise. In this embodiment, the music distributor or a merchandise distributor may set up the promotional account. The funds, credits or specific goods may be associated with the promotional account. The consumer may use funds or credits to obtain merchandise, such as t-shirts, posters and a wide variety of other goods or services, including trips, and concert tickets. The consumer may make selections or redeem the promotion, such as via a website 409. In response, the merchandise may be delivered to the consumer. In other embodiments, the merchandise or services need not be given away but may be provided to the consumer at a reduced price.

The promotional account may be utilized in a variety of ways to promote other goods or services. For example, in the case of a traditional CD, the promotional account may provide the purchaser with the opportunity to win related merchandise, such as a t-shirt regarding that artist or downloadable copies of the music on that CD or other music belonging to that artist which is not on that CD. In this manner, a consumer is enticed to pay for his or her own copy of the CD or other media rather than download the content in order to obtain the promotional goods.

As one aspect of the invention, these types of accounts may be manipulated in the manners described above. For example, in one embodiment, credits such as points may be associated with the promotional accounts. A consumer may accumulate and aggregate points in order to achieve point levels sufficiently high to obtain desired music or other goods. For example, a music distributor may assign point values to merchandise. A t-shirt may be 1000 points, while a complete CD compilation may be 50,000 points. Points which are associated with promotional accounts may vary. For example, if a consumer purchases a single CD, the associated promotional account may have 500 assigned points. For a two-CD set, the associated points may be 1500.

The consumer may aggregate points by merging promotional accounts. Merging may be accomplished in a variety of manners, as described above. For example, the points associated in one account may be moved to the other, or the points or other credits associated with two or more accounts may be merged into a single new account. Merged accounts may be eliminated or closed, or kept open. For example, if the consumer needs 50,000 points to obtain particular goods, the consumer may continue to acquire promotional accounts and aggregate the associated points until that point level is achieved. The consumer may then utilize the combined points to obtain the desired merchandise. FIG. 2(d) illustrates such an arrangement. As illustrated, a consumer may have his or her own account 404a. This account 404a may have a plurality of points or monies 420a associated therewith. A consumer may also have been assigned a promotional account 404b and/or an account created by a third party, such as a gift or allowance account 404c. Each of these accounts may likewise have points or monies 420b,420c associated therewith.

The consumer may be entitled to merge the accounts or the points/monies associated therewith in a variety of combinations. As illustrated, for example, the consumer may merge the points or monies associated with any or all of the accounts to a single total point or money value 420d. This value may be associated with any one of the accounts, such as the consumer's original account 404a, or a completely new combined account 404d.

A consumer may access or obtain and manage accounts and account information. A consumer may access his or her accounts to merge points, check points or redeem points. A consumer may access his or her account or accounts to add funds or engage in other activities. For example, as described above, the account provider may provide access to such information via a website.

In one embodiment, the music or account provider may utilize consumer information for a variety of purposes. For example, a music distributor may monitor the consumer's accounts for music or other qualified purchase events. As detailed, points or the like may be associated with those transactions. Based upon accumulated points or other criteria, such as the value of transactions or the number of transactions, the consumer may be entitled to an award. For example, a particular music provider, such as a particular record label, may indicate to the account provider that a promotional account is to be awarded to each consumer who purchases a certain amount of music during a certain period of time.

In one embodiment, a variety of information may be associated with a single account. For example, a consumer may establish an account. Monetary value may be associated with the account, such as for making purchases. The monetary value may be utilized by the consumer to make on-line purchases, as described above, and/or purchases at a traditional store. Purchase transaction data may be associated with the same account. For example, a retailer may transmit purchase information to the consumer's account. In addition, promotional information such as awarded points or credits may be associated with the same account. In one embodiment, promotional points are directly associated with the account. For example, in the case of a purchase entitled to promotional points, the point information may be stored directly in the consumer's account. As indicated, the consumer may be awarded a promotional account by other means, such as purchase of a media. In that event, the points or other promotion information may be merged into the consumer's account.

In this method, a consumer has a single source of information for a variety of transactions. This information may be used for a variety of purposes, including purchases and redemption of awards. The information may be managed, such as by the consumer's access of a website via which the information may be obtained. As detailed above, access and management of the account information may be by use of account access information.

FIG. 2(e) illustrates a system facilitating a plurality of the transactions/events described above. As illustrated, an account may be established with an account provider 500. In one embodiment, the account may be established by a consumer 502. The consumer may, for example, associate money or monetary value 504 with the account. In return, the consumer 502 is provided with account information 506.

The consumer may utilize the account to obtain merchandise, including music data and traditional media containing music. For example, the consumer 502 may purchase merchandise, such as a CD 508, from a store operated by a retailer 510.

As described above, the consumer 502 may provide his or her account information 506 to the retailer 510 in order to make this purchase. The retailer 510 preferably utilizes the account information 506, such as by transmitting it to the account provider 500, to verify and obtain the funds 504 to complete the purchase. As also described above, the retailer 510 may transmit other information, such as purchase information which is associated with the consumer's account. In this regard, it is noted that the consumer 502 may also make the purchase without using his or her account, but instead by simply directly providing monies, such as cash or coins. In response to such a purchase, the purchase data may be transmitted to the consumer's account for use as described above.

The consumer may also utilize his or her account to obtain merchandise from an online source, such as a merchandise provider's website 512 via the Internet 514. As illustrated, the consumer 502 once again transmits account data to the provider to facilitate the purchase. In response, merchandise is provided to the consumer 502. This merchandise may include data 516, such as data representing music. The merchandise may also comprise physical goods 518, such as shipped from a warehouse 520.

As described above, a consumer may also utilize an account which was assigned or given to him or her by a third party 522. For example, a third party 522 may set up an account as an allowance or gift account. The third party 522 contacts the account provider 500 and sets up the account in the manner described above, such as including associating monetary value with the account. The account information 506 is again provided to the consumer 502 to permit the consumer to enter into various transactions, such as with a retailer 510 or provider 512.

As also described above, a party may wish to create a promotional account. For example, a promoter such as a music distributor 524 may set up an account with an account provider 500. In one embodiment, account information may be provided to a distributor 526 for distribution to consumers 502. The distributor 526 may comprise a variety of entities, including a marketing company. Once provided with the account information, the consumer 502 may utilize the promotional account information to obtain merchandise, such as from a retailer 510 or provider 512.

The promoter 524 may fund or provide the merchandise, such as distributed from a warehouse 520 or by paying or otherwise funding retailers and others who give the merchandise away.

As also illustrated, the music distributor 524 may associate the promotional account information with a traditional media, such as a CD. The CD including the account information may be provided to retailers 510 and others for sale or other distribution to consumers 502. As illustrated, a consumer 502 may purchase a CD including promotional account information from a retailer 510. As noted above, this purchase can be effected by use of another account, such as a consumer's account or a gift account. As a result of the purchase, the consumer 502 is provided with promotional account information which the consumer may use to obtain other merchandise.

It will be appreciated that a wide variation in the system and transactions as described above is possible in accordance with the invention, and that the figures are simply illustrative of a variety of the concepts and principles of the invention. It will be appreciated, for example, that monies associated with an account may be represented by points, credits or the like. One or more of the parties may perform a greater or lesser number of the functions described. For example, a music distributor may also act as an account provider, as well as operate a website from which merchandise such as goods or music data may be obtained.

The systems, methods and accounts of the invention have numerous advantages. First, a method is provided by which a consumer may obtain specific music content without having to pay when no content is desired and without having to pay for undesired content. The method permits a consumer to obtain music in a data form which permits the music to easily be stored and replayed. The method allows the consumer to obtain the desired music content from a home computer or similar source without having to travel to a traditional brick and mortar store or wait for shipment of a physical media.

This method also benefits the music industry. Because consumers can obtain specific content, they are more likely to desire to pay for the content. The music industry can also track consumer activity and reward the desirable activity such as frequent music purchases.

The use of accounts has numerous advantages as well. As described above, use of the accounts of the present invention enables certain consumers to purchase music when they might otherwise have difficulty doing so. A minor may be provided with an account an utilize the account to legally purchase music content instead of attempting to obtain an illegal copy from another source.

The use of promotional accounts has numerous advantages. A primary advantage to the music industry is that a consumer is enticed to purchase music legally in order for the right to obtain a promotional account. In one embodiment, certain music or other merchandise may be made available to consumers only by use of promotional accounts. In this manner, a consumer who desires that content or merchandise must legally purchase music in order to access those goods.

The consumer is equally rewarded. The consumer, simply by purchasing traditional music media, is entitled to additional goods or content.

It will be understood that the above described arrangements of apparatus and the method therefrom are merely illustrative of applications of the principles of this invention and many other embodiments and modifications may be made without departing from the spirit and scope of the invention as defined in the claims.

I claim:

1. A method facilitating the purchase of music contained on traditional media comprising the steps of:
establishing a promotional account, said account representing entitlement to an award;
associating information identifying said promotional account with a media storing data representing music content;
selling said media to a consumer;
receiving said information identifying said promotional account from said consumer; and
awarding said award to said consumer.

2. The method in accordance with claim 1 wherein said media comprises a compact disc (CD).

3. The method in accordance with claim 2 wherein said CD is housed inside a jewel box and said information is printed on a media located inside said box.

4. The method in accordance with claim 2 wherein said step of receiving said information comprises accepting said information over a communication link established from a computing device utilized by said consumer and a remote server.

5. The method in accordance with claim 1 wherein said award comprises data representing music content and said awarding step comprises transmitting said data to said consumer for use by said consumer.

6. The method in accordance with claim 1 wherein said award comprises music related merchandise and said awarding step comprises delivering said merchandise to said consumer.

7. The method in accordance with claim 1 including the step of establishing a communication link from a central host with a computing device utilized by said consumer and wherein said receiving step comprises receiving said information at said host over said communication link.

8. A method of promoting the sale of music comprising:
creating a plurality of promotional accounts;
associating a plurality of points with each of said accounts;
associating information identifying one of said promotional accounts with a media storing data representing music content;
distributing a first and a second media to a consumer;
accepting information identifying a first promotional account and a second promotional account associated with said first and second media from said consumer; and
merging said first and second promotional accounts into a single account having a total number of points comprising the sum of said plurality of points associated with said first and second promotional accounts.

9. The method in accordance with claim 8 wherein said first and second promotional accounts are merged into either said first or second account.

10. The method in accordance with claim 8 wherein said first and second promotional accounts are merged into a new third account.

11. The method in accordance with claim 8 including the step of accepting one or more of said total number of points in exchange for merchandise.

12. The method in accordance with claim 8 including the step of redeeming one or more of said total number of points for merchandise.

13. The method in accordance with claim 8 including the step of transmitting website information to said consumer, said website information including information regarding one or more prizes which may be obtained in exchange for a plurality of points associated with said single account.

14. The method in accordance with claim 8 wherein said step of associating said information identifying said promotional account comprises printing said information on an insert and locating said insert in packaging containing said media.

15. A method of utilizing an account to promote the sale of music and related merchandise comprising the steps of:
establishing a first account;
distributing information identifying said first account to a consumer;
associating information regarding purchases of media storing data representing music by said consumer with said first account, said information comprising a number of points representing said purchases;
associating information regarding a number of promotional points awarded to said consumer with said first account; and
permitting said consumer to redeem said points associated with said first account for merchandise.

16. The method in accordance with claim 15 including the steps of creating a promotional account having said promotional points associated therewith, distributing information identifying said promotional account to said consumer, accepting said information from said consumer and associating said promotional points of said promotional account with said first account in response to an input from said consumer.

17. The method in accordance with claim 15 wherein said step of associating information regarding purchases of media comprises receiving information from a seller of said media regarding said purchases and the identity of said first account.

18. The method in accordance with claim 15 including the step of associating monetary information with said first account and utilizing said monetary information to facilitate said purchases.

19. The method in accordance with claim 18 wherein said monetary information represents monetary value associated with said account provided by said consumer.

20. The method in accordance with claim 18 wherein said monetary information represents monetary value associated with said account provided by a third party.

21. A method of facilitating digital music purchases by a consumer using a financial system, comprising:
establishing a communications link between a first server and a second server at a remote location;
identifying a user of the first server;
transmitting data to be stored from the first server to the second server via the communications link;
associating identifying information regarding the user with the transmitted data;
choosing a digital music selection;
paying for the music selection with the music financial account; and
downloading the music selection from said second server to the first server via said communication link.
